(19) United States
(12) Patent Application Publication
(10) Pub. No.: US 2011/0284239 A1
(43) Pub. Date: Nov. 24, 2011

(54) NON-STICK ARTICLES

(76) Inventors: Jamie Burgess, Houston, TX (US); Zhongxin Huo, Katy, TX (US); Stanley N. Milam, Houston, TX (US); Sandrine Poteau, Sugar Land, TX (US); Karthik Ramanathan, Houston, TX (US); John Ratulowski, Missouri City, TX (US)

(21) Appl. No.: 13/144,094

(22) PCT Filed: Jan. 8, 2010
(86) PCT No.: PCT/US10/20420

§ 371 Date: Aug. 12, 2011

Related U.S. Application Data
(60) Provisional application No. 61/143,964, filed on Jan. 12, 2009.

(51) Int. Cl. E21B 43/00; F16L 9/14; B65D 90/02; B32B 1/02

(52) U.S. Cl. 166/369; 428/34.1; 138/146; 220/62.11

(57) ABSTRACT

There is disclosed a non-stick apparatus, comprising a liquid storage or conveyance article comprising a first material; a coating on an internal surface of the article comprising a second material; wherein the second material comprises a critical surface tension value less than 75 mN/m and a hardness value of at least 5 measured on a Moh's scale.

### RELATED APPLICATIONS

The present application claims priority to co-pending U.S. Provisional Application 61/143,964, filed Jan. 12, 2009, which is herein incorporated by reference in its entirety.

### FIELD OF INVENTION

There are disclosed liquid storage and conveyance articles with an improved non-stick coating.

### BACKGROUND

Various coatings and other surface treatments have been applied to the internal and external surfaces of pipes, tanks, and other liquid storage and conveyance articles.

U.S. Patent Publication Number 2006/0186023 discloses a method of transporting a produced fluid through a pipe while limiting deposits at a desired pipe inner-wall location comprising providing a pipe having an inner surface roughness Ra less than 2.5 micrometers at said desired pipe inner-wall location, forcing the produced fluid through the pipe, wherein the produced fluid has a wall shear stress of at least 1 dyne per centimeter squared at said desired pipe inner-wall location. U.S. Patent Publication Number 2006/0186023 is incorporated herein by reference in its entirety.

U.S. Pat. No. 7,300,684 discloses the coating of internal surfaces of a workpiece is achieved by connecting a bias voltage such that the workpiece functions as a cathode and by connecting an anode at each opening of the workpiece. A source gas is introduced at an entrance opening, while a vacuum source is connected at an exit opening. Pressure within the workpiece is monitored and the resulting pressure information is used for maintaining a condition that exhibits the hollow cathode effect. Optionally, a pre-cleaning may be provided by introducing a hydrocarbon mixture and applying a negative bias to the workpiece, so as to sputter contaminants from the workpiece using argon gas. Argon gas may also be introduced during the coating processing to re-sputter the coating, thereby improving uniformity along the length of the workpiece. The coating may be a diamond-like carbon material having properties which are determined by controlling ion bombardment energy. U.S. Pat. No. 7,300,684 is incorporated herein by reference in its entirety.

There is a need in the art for non-stick, improved, lower cost, and/or alternative coatings for the internal surfaces of liquid storage and conveyance articles.

### SUMMARY OF THE INVENTION

One aspect of invention provides a non-stick apparatus, comprising a liquid storage or conveyance article comprising a first material; a coating on an internal surface of the article comprising a second material; wherein the second material comprises a critical surface tension value less than 75 mN/m and a hardness value of at least 5 measured on a Moh's scale.

Another aspect of invention provides a method of producing hydrocarbons, comprising drilling a well on a sea floor; producing hydrocarbon containing fluids to a wellhead on the sea floor; connecting a pipe from the wellhead to a location on land or a floating production platform or vessel; and coating an internal surface of the pipe with a material comprising a critical surface tension value less than 75 mN/m and a hardness value of at least 5 measured on a Moh's scale.

Advantages of the invention include one or more of the following:

Improved non-stick coatings for pipes and tanks;

Improved non-scratch coatings for pipes and tanks;

Lower cost non-stick coatings for pipes and tanks; and/or

Alternative non-stick coatings for pipes and tanks.

### BRIEF DESCRIPTION OF THE DRAWINGS

FIG. 1 shows the Zisman plot derived from contact angle measurements of tungsten carbide.

FIG. 2 shows the Zisman plot derived from contact angle measurements of surface Z.

FIG. 3 shows the Zisman plot derived from contact angle measurements of surface TK-2.

FIG. 4 shows the Zisman plot derived from contact angle measurements of surface TK-7.

FIG. 5 shows the Zisman plot derived from contact angle measurements of surface TK-805.

### DETAILED DESCRIPTION

Embodiments disclosed herein are directed to articles of pipes having a surface which is coated with tungsten carbide. In particular, embodiments disclosed herein are directed to the use of tungsten carbide as coatings to make non-sticking and non-scratching articles of pipes. Other embodiments disclosed herein are directed to petroleum production systems, refineries, and pipelines thereof, the pipelines having an interior surface which is coated with tungsten carbide. In particular, embodiments disclosed herein are directed to the use of tungsten carbide as coatings on inner surfaces of pipelines to reduce or prevent undesired solid deposition in such petroleum production systems and refineries.

The petroleum industry utilizes virtually uncountable kilometers of pipes or tubular sections of various sizes. These pipelines may be found in on-shore or off-shore structures, underground or underwater systems, pressure vessels or any related structures. Pipelines, conduits, and storage vessels are used, in the petroleum industry, for transporting and/or storing various hydrocarbons, including crude oil, refined products, and natural gas through, for example, down-hole pipes for conveying such hydrocarbons from underground deposits to the earth surface and as pipelines for the long distance transportation of hydrocarbons across the earth surface and/or under, on, or from the sea floor to a floating vessel or the shore. Furthermore, one skilled in the art would appreciate that the production stream of hydrocarbons may include other materials (dissolved solids) therein, including heavy organics such as asphaltenes and waxes, small hydrocarbons forming hydrates, produced water including salt water and brine, which can lead to salt scale precipitation, various kinds of corrosive chemicals, abrasives and slurries.

While the production stream may leave the wellhead at an elevated temperature, it begins to cool and the pressure is reduced when compared to wellhead pressure, rapidly being chilled as it travels many miles in a deepwater environment, where temperatures may be on the order of 5° C. These changes in temperature and pressure may result in the precipitation of dissolved solids contained within the hydrocarbon production stream and/or the creation of new solids. For example, the dissolved asphaltenes and waxes may form solids that adhere to the internal walls of the pipeline. Specifically, long-chain paraffins present in the production stream may crystallize and form large wax crystals having a sponge-like structure which leads to the inclusion of other constituents in the crystal structures and thus to their deposition on the pipeline interior surface and to the clogging of such production equipment. Additionally, asphaltenes (large, polar polyaromatics) are a major source of pipelines blockage as they not only precipitate when the temperature and pressure are reduced but they also interact with other heavy organics such as paraffins to precipitate. Moreover, low molecular weight hydrocarbons present in the production stream may be trapped in a lattice of water molecules to form solid hydrates that may likewise adhere to the walls of the pipeline. Further, inorganic solids including barite, calcite, salts may precipitate as scale on the pipeline, alone, or in combination with the heavy organics. As such solids precipitate onto the interior surfaces of the pipelines and conduits, they can, over time reduce the throughput of the pipeline and the production from the well.

Thus, in accordance with embodiments of the present disclosure, such pipelines may be provided with a coating on the interior surface thereof to reduce or prevent solid deposition thereon, particularly in pipelines are located in fields, such as subsea fields, in which temperature and pressure are reduced. In particular embodiments, such pipelines may be provided with a tungsten carbide coating thereon to reduce or prevent solid deposition. Such conduits may be formed of steel, such as carbon or low alloy steel, or of plastic, such as polyethylene; however, no limitation is intended on the type of material that may be coated with the tungsten carbide coatings of the present disclosure. It is also within the scope of the present disclosure that the substrate material of the pipelines may be a single layered material or may be already coated with one or more layers of various other materials such as a protective coating which forms a physical barrier between the corrosive environment and the steel surface.

According to the present disclosure, there is provided an article of a pipe or a vessel having an inner surface coated with tungsten carbide. In one embodiment, the coating is monotungsten carbide, WC. In another embodiment, ditungsten carbide, W₂C, is used. In yet another embodiment, the coatings contain a mixture of tungsten carbides with each other. In yet another embodiment, the coatings contain a mixture of tungsten carbides with tungsten or free carbon.

Tungsten carbide has a critical surface energy γ_{c} of approximately 20 mN/m. The critical surface tension of a solid surface is an indication of its relative hydrophobic or hydrophilic character. A low critical surface tension means that the surface has a low energy per unit area. The lower the value is for a surface, the more unlikely sticking will occur on such surfaces. The tungsten carbide γ_{c} value is lower than most commercially available coatings as for example carbon steel (γ_{c}=˜100 mN/m), copper (γ_{c}=˜140 mN/m) and gold (γ_{c}=˜230 mN/m), and comparable to polytetrafluoroethylene (γ_{c}=˜18 mN/m) typically used in pipes applications. At such a surface energy level, a tungsten carbide substrate may generally have a critical surface tension less than most liquids, which are typically greater than 20 mN/m. Thus, so long as the a substrate has a lower critical surface tension than a liquid, solid deposition is unlikely, as such solids may deposit slowly, and if they deposit, removal of such deposits is easier due to the low surface energy level of the tungsten carbide coating. Such tungsten carbide coatings may thus greatly reduce the adherence of solids on the interior surfaces of petroleum production systems and refineries, and during cleaning of the surfaces after use.

In other embodiments, other carbide coatings may be used alone or in combination with tungsten carbide, for example titanium carbide, tantalum carbide, and/or zirconium cardie.

Moreover, such tungsten carbide coatings may be extremely hard (Moh's hardness of about 9) and wear resistant. Such inherent material properties of tungsten carbide may render the tungsten carbide-coated pipes of the present disclosure scratch-, and/or abrasion-resistant. Such properties may also allow such pipes articles to be washed with any known means, including scouring brushes or pads, without any concern for their integrity. In comparison, PTFE coatings generally have a Moh's hardness of less than about 3. Tungsten carbide coatings may also provide an improved resistance to corrosion to the coated pipelines.

Such articles of pipes may be formed of a variety of materials known in the art of pipes, such as for example, steel, copper, aluminum, titanium, cast iron, or stainless steel; however, no limitation is intended on the type of material that may be coated with the tungsten carbide coatings of the present disclosure. Further, it is also within the scope of the present disclosure that the substrate material of the articles may be a single layered material or it may be bonded as a clad composite to layers of various other materials.

In one embodiment, of the present disclosure, the deposited tungsten carbide coating may have a thickness of about 1 to about 20 μm. In another embodiment, the tungsten carbide layer has a thickness of about 2 to about 10 μm.

In one embodiment, the tungsten carbide coating of the present disclosure is applied as a single layer on the substrate material. In another embodiment, the tungsten carbide coating is deposited as multiple layers on the substrate material.

In yet another embodiment of the present disclosure, the substrate to be coated has a primer layer which allows the tungsten coatings to be more strongly bonded to the substrate. This primer layer may be any type of appropriate component known by one with skill in the art and may depend on the type of substrate and on the composition of the tungsten coating.

In yet another embodiment, the tungsten carbide coating may comprise a metal binder to increase the strength of the bonding of the coating to the substrate and thus to provide additional durability of the coated layer.

The deposition of the tungsten carbide coatings may be done by any method known by one with skill in the art. Such methods may comprise the steps of: (1) roughening/polishing and cleaning the surface of the substrate to be coated so as to facilitate the attachment and bonding of the further coating thereon; (2) applying the tungsten carbide coating on the roughened/polished and cleaned surface.

In order to provide superior stick resistant properties, the surface to be coated may be polished prior to coating. The polishing may be a mechanical polishing using abrasive papers, for example alumina abrasive paper, having a grain increasingly fine or an electropolishing. It is, of course, understood that a higher luster surface requires additional polishing with a buffing wheel and medium buffing abrasive which adds some additional cost to the finished pipes. Thus, a compromise between added cost and added stick resistance may be made in a commercial setting. In various embodiments, the treated surface may have a surface roughness of less than about 0.5 μm (about 20 microinches). In one embodiment, the surface has a roughness of between about 0.05 and 0.25 μm (between 2 and 10 microinches). In another embodiment, the surface has a roughness between about 0.05 and 0.20 μm (between 2 and 8 microinches). In yet another embodiment, the surface has a roughness of between about 0.05 and 0.13 μm (between 2 and 5 microinches).

A high degree of surface cleanliness may be used prior to coating the substrate layer. The dirty areas would act as a mask and prevent adhesion of the tungsten carbide coating layer. The surfaces of the article of pipes which are going to be coated may be cleaned, washed, degreased and dried by any techniques known by one with skill in the art.

The tungsten carbide coatings may be applied by means of physical vapor deposition (PVD), chemical vapor deposition (CVD), by a roller coating techniques, electrodeposition, thermal spray, or by any other coating technique known by one skilled in the art.

In one embodiment, the pipelines are prepared and coated in situ. In another embodiment, the different parts of the pipelines may be individually prepared and coated before being shaped and/or interconnected with a plurality of similarly produced pipe segments to construct a coated pipeline. In yet another embodiment, the pipelines' parts may be individually prepared and coated after having been shaped into the desired configuration. Alternatively, the pipelines' segments may be individually prepared and coated after having been shaped and/or interconnected with a plurality of similarly produced pipe segments to construct a coated pipeline but before being installed in place.

In the case where the coating is applied to in place pipes, the first step of the preparation process may be the displacement of the pipeline product from the line with water or any other suitable displacement fluid. The pipeline may then be pressure tested for leakage, and if none is found suitable pigs may be conveyed through the line to mechanically and/or chemically remove internal solids from the interior of the line together with any corrosion materials which are adhered to the pipeline interior walls. After removal of solids from the pipeline, several flushing steps using water and/or other cleaning fluids may be required, depending on whether or not the pipeline still contains certain hydrocarbons, such as paraffins or other hydrocarbon components. To increase the strength of the bond between the coating and the substrate, the bonding area may be increased. This may be carried out by mechanical abrasion of the surface such as sand blasting. The pipeline may then finally cleaned in order to remove all final contaminants such as dirt. In one embodiment, the pipeline is flushed with a cleaning agent followed by flushing with fresh water. In another embodiment of the present disclosure, cleaning may be attained with the use of ultrasound. After completion of the cleaning process, pressurized air may be flowed through the pipeline to dry the interior wall surface.

The tungsten carbide coatings may be applied by such methods as physical vapor deposition (PVD), chemical vapor deposition (CVD), roller coating techniques, electrodeposition, thermal spray, slurry coating, or by any other coating technique known by one skilled in the art. The particular metal or plastic substrate, as well as other parameters, will determine the method of application. In the case where the coating is realized on in place pipes, the coating material may be sent through attached tubing and sprayed onto the inner surface of the pipe at the desired location; however, no limitation is intended on the method used to coat the in place pipelines or the individual parts of pipelines with the tungsten carbide coatings of the present disclosure.

Further, one skilled in the art would appreciate that by varying the composition of the reaction mixture and of the parameters of the process (temperature of the substrate, flow rate, total pressure in the reaction mixture, temperature of the gases supplied, etc.), it is possible to obtain a variety of coatings having varied properties, depending on the desired application.

Thus, tungsten carbide as described above, when applied as a surface coating to the interior of petroleum production systems and refineries, offers: (a) an effective prevention against deposition of inorganic and/or organic solids; (b) a scratch and abrasion resistance to the pipelines; and (c) an improved resistance to corrosion to the coated pipelines. Additionally, when solid deposition does occur, its removal may be of greater ease due to the low surface energy.

When making pipes, it may difficult to polish the entire interior surface. In such circumstances, according to an embodiment of the present disclosure, the tungsten carbide coating may be applied to a polished and cleaned flat metal sheet prior to its formation into the desired shape of the pipe. Alternatively, the coating may be applied after the pipe material has been polished, cleaned, shaped into the particular configuration and cleaned again.

Although such tungsten carbide coatings are applied to the inner surface of pipes, it may also be desirable to employ such coatings on the outer walls.

While preferred embodiments of the invention have been herein described, it will be apparent to those skilled in the art that various modifications may be made in these embodiments without departing from the spirit of the present disclosure. Such modifications are all within the scope of this invention.

### Examples

The following experiments were aimed at measuring contact angles and deriving there from the critical surface tensions of various coatings on metallic substrates with a series of pure liquids in order to compare tungsten carbide coatings with other commercially available coatings.

These experiments were conducted on flat, non-porous samples of solids. Five plates were used for analysis: one uncoated highly polished tungsten carbide WC plate, three polymer coated plates labeled “TK-2”, “TK-7”, “TK-805”, commercially available from Tuboscope Pipeline Services (Houston, Tex.), and “Z”. For analysis, sample coupons (2.54 cm (1 inch) in width) were cut from the larger plates using a high-speed rotary cutting wheel so that each coated sample could be accommodated by the measurement apparatus.

Contact angles were measured for a range of solvents (see Table 1 below) of known surface tension (γ_{LV}) using an apparatus that digitally records the droplet image. In all cases, 10 μL droplets of a given solvent were deposited on the surface of the sample coupon at randomly selected locations and replicate measurements (n=6) of the contact angle were made on both the left- and right side of the droplet image (see Table 2a to c below).

TABLE 1
Solvent series corresponding surface tensions used to
derive the critical surface tension of sample coupons

| | Surface Tension γ_{LV} |
|---|---|
| Solvent | (mN/m at 20° C.) |
| Water | 72.8 |
| Glycerol | 64.0 |
| Ethylene Glycol | 47.7 |
| PEG-200 | 43.5 |
| Decanol | 28.5 |
| Cyclohexanone | 34.6 |
| Diiodomethane | 50.8 |
| Formamide | 58.2 |

TABLE 2a
Contact angles measured for Tungsten Carbide samples for
development of Zisman plots (all angles are in degrees)

| | Tungsten Carbide | | | | | |
|---|---|---|---|---|---|---|
| | Angle | Angle | Angle | Angle | Angle | Angle |
| Solvent | 1 | 2 | 3 | 4 | 5 | 6 |
| Water | 37.5 | 36.7 | 39.2 | 33.7 | | |
| Glycerol | 28.2 | 25.3 | 24.7 | 25.8 | | |
| Ethylene | 34.4 | 29.4 | 28.3 | 25.8 | 29.9 | 27.3 |
| Glycol | | | | | | |
| PEG-200 | 22.4 | 21.1 | 20.3 | 20.7 | 21.9 | 20.7 |
| Decanol | 10.7 | 8.9 | 7.4 | 9.4 | | |
| Cyclohexanone | 5.1 | 4.3 | 3.3 | 2.7 | | |
| Diiodomethane | | | | | | |
| Formamide | | | | | | |

TABLE 2b
Contact angles measured for TK-2 and TK-7 samples for development of Zisman plots (all angles are in degrees)

| | TK-2 | | | | | | TK-7 | | | | | |
|---|---|---|---|---|---|---|---|---|---|---|---|---|
| | Angle | Angle | Angle | Angle | Angle | Angle | Angle | Angle | Angle | Angle | Angle | Angle |
| Solvent | 1 | 2 | 3 | 4 | 5 | 6 | 1 | 2 | 3 | 4 | 5 | 6 |
| Water | 76.7 | 75.9 | 71.7 | 76.1 | 74.4 | 75.6 | 74.1 | 74.6 | 72.9 | 73.2 | 72.1 | 72.3 |
| Glycerol | 52.9 | 53.4 | 57.4 | 54.9 | 56.6 | 56.4 | 56.8 | 56.6 | 56.4 | 56.8 | | |
| Ethylene | 55.7 | 55.9 | 52.5 | 54.4 | 54.9 | 54.8 | 38.8 | 38.6 | 37.8 | 38.7 | | |
| Glycol | | | | | | | | | | | | |
| PEG-200 | 30.8 | 31.6 | 29.5 | 25.7 | 29.6 | 30.2 | 12.7 | 12.3 | 11.7 | 11.8 | | |
| Decanol | | | | | | | | | | | | |
| Cyclohexanone | 6.8 | 7 | 7.6 | 7.3 | | | | | | | | |
| Diiodomethane | 37.6 | 37.3 | 36.9 | 37.4 | | | 42.4 | 43.1 | 46.9 | 46.7 | | |
| Formamide | 47.6 | 46.9 | 47.2 | 47 | | | | | | | | |

TABLE 2c
Contact angles measured for TK-805 and surface “Z” samples for development of Zisman plots (all angles are in degrees)

| | TK-805 | | | | | | Surface “Z” | | | | | |
|---|---|---|---|---|---|---|---|---|---|---|---|---|
| | Angle | Angle | Angle | Angle | Angle | Angle | Angle | Angle | Angle | Angle | Angle | Angle |
| Solvent | 1 | 2 | 3 | 4 | 5 | 6 | 1 | 2 | 3 | 4 | 5 | 6 |
| Water | 68.2 | 62.1 | 63.9 | 70.2 | 65.9 | 68.2 | 36.1 | 37.2 | 37.9 | 38.1 | | |
| Glycerol | | | | | | | 38.5 | 39.2 | 40.8 | 38.8 | | |
| Ethylene | | | | | | | 34.2 | 34.9 | 36.7 | 37.2 | | |
| Glycol | | | | | | | | | | | | |
| PEG-200 | 23.1 | 23.8 | 23.9 | 24.1 | | | 22.7 | 22.4 | 21.4 | 22.2 | | |
| Decanol | 7.1 | 6.4 | | | | | 12.1 | 11.8 | 11.7 | 11.5 | | |
| Cyclohexanone | 5.1 | 5.4 | | | | | | | | | | |
| Diiodomethane | 49.2 | 49.8 | 48.9 | 49.4 | | | 37.6 | 37.5 | 37.4 | 37.9 | | |
| Formamide | 36.7 | 37.5 | 36.9 | 37 | | | | | | | | |

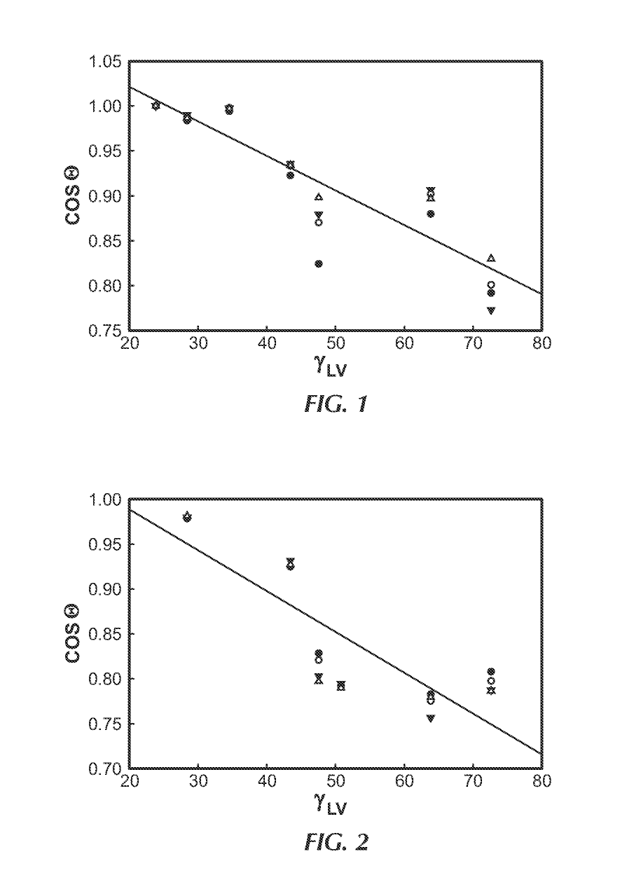

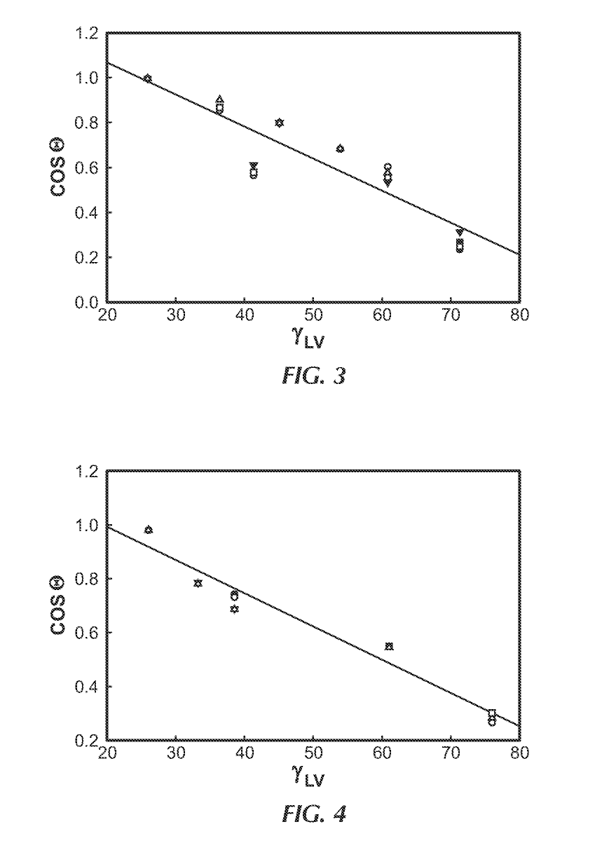

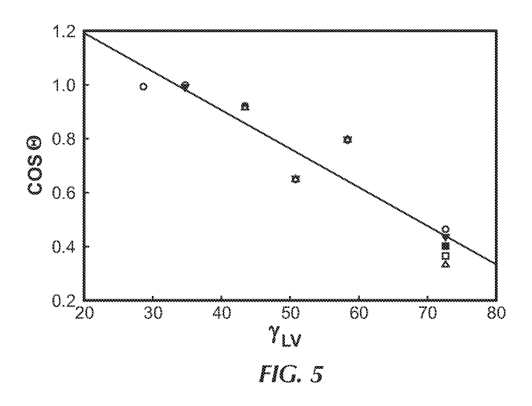

The critical surface tension was determined for each surface by the method of Zisman. In this method, the relationship between the known surface tension (γ_{LV}) of a series of solvents and the cosine of the measured contact angle (cos θ) is linearly extrapolated to cos θ=1 (see FIGS. 1 to 5—all γ_{LV} are in mN/m), where then the surface tension at this value is equivalent to the critical surface tension (γ_{c}) of the surface (see Table 3 below).

TABLE 3
Critical surface tensions determined from
linear extrapolation of Zisman plots

| | | Critical Surface |
|---|---|---|
| Surface | r² | Tension (γ_{c}, mN/m) |
| Tungsten | 0.8039 | 25.7 |
| Carbide | | |
| Z | 0.6871 | 17.3 |
| TK-2 | 0.8009 | 33.3 |
| TK-7 | 0.9580 | 39.5 |
| TK-805 | 0.8503 | 33.6 |

Advantageously, embodiments of the present disclosure may provide for one or more of the following. Tungsten carbide, when applied as a surface coating to pipes, sauce pan, frying pan, stock pan, casserole or any other food preparation surfaces, may offer (a) a substantial resistance to sticking foods to the surface; (b) a scratch resistance to the pipes article; and (c) a relatively long service life. Further, such coatings may be heat, corrosion, and/or oxidation resistant. Additionally, while providing a surface energy (and non-sticking) similar to polytetrafluoroethylene coatings conventionally used in coating pipes, the tungsten carbide coatings may provide an alternative with similar expected properties.

### Illustrative Embodiments

In one embodiment, there is disclosed a non-stick apparatus, comprising a liquid storage or conveyance article comprising a first material; a coating on an internal surface of the article comprising a second material; wherein the second material comprises a critical surface tension value less than 75 mN/m and a hardness value of at least 5 measured on a Moh's scale. In some embodiments, the second material comprises a critical surface tension value less than 50 mN/m. In some embodiments, the second material comprises a critical surface tension value less than 25 mN/m. In some embodiments, the second material comprises a hardness value of at least 7 measured on a Moh's scale. In some embodiments, the second material comprises a hardness value of at least 8 measured on a Moh's scale. In some embodiments, the first material is selected from the group consisting of steel, stainless steel, cast iron, copper, and plastic. In some embodiments, the second material comprises a carbide. In some embodiments, the second material comprises tungsten carbide. In some embodiments, the article comprises a pipe. In some embodiments, the pipe comprises a hydrocarbon liquid, for example crude oil. In some embodiments, the article comprises a tank.

In one embodiment, there is disclosed a method of producing hydrocarbons, comprising drilling a well on a sea floor; producing hydrocarbon containing fluids to a wellhead on the sea floor; connecting a pipe from the wellhead to a location on land or a floating production platform or vessel; and coating an internal surface of the pipe with a material comprising a critical surface tension value less than 75 mN/m and a hardness value of at least 5 measured on a Moh's scale.

Those of skill in the art will appreciate that many modifications and variations are possible in terms of the disclosed embodiments of the invention, configurations, materials and methods without departing from their spirit and scope. Accordingly, the scope of the claims appended hereafter and their functional equivalents should not be limited by particular embodiments described and illustrated herein, as these are merely exemplary in nature.

1. A non-stick apparatus, comprising:
a liquid storage or conveyance article comprising a first material;
a coating on an internal surface of the article comprising a second material;
wherein the second material comprises a critical surface tension value less than 75 mN/m and a hardness value of at least 5 measured on a Moh's scale.

2. The apparatus of claim 1, wherein the second material comprises a critical surface tension value less than 50 mN/m.

3. The apparatus of claim 1, wherein the second material comprises a critical surface tension value less than 25 mN/m.

4. The apparatus of claim 1, wherein the second material comprises a hardness value of at least 7 measured on a Moh's scale.

5. The apparatus of claim 1, wherein the second material comprises a hardness value of at least 8 measured on a Moh's scale.

6. The apparatus of claim 1, wherein the first material is selected from the group consisting of steel, stainless steel, cast iron, copper, and plastic.

7. The apparatus of claim 1, wherein the second material comprises a carbide.

8. The apparatus of claim 1, wherein the second material comprises tungsten carbide.

9. The apparatus of claim 1, wherein the article comprises a pipe.

10. The apparatus of claim 1, wherein the article comprises a tank.

11. A method of producing hydrocarbons, comprising:
drilling a well on a sea floor;
producing hydrocarbon containing fluids to a wellhead on the sea floor;
connecting a pipe from the wellhead to a location on land or a floating production platform or vessel; wherein
the internal surface of the pipe is coated with a material comprising a critical surface tension value less than 75 mN/m and a hardness value of at least 5 measured on a Moh's scale.
